(19) United States
(12) Patent Application Publication
(10) Pub. No.: US 2011/0277944 A1
(43) Pub. Date: Nov. 17, 2011

(54) VENETIAN BLIND SLAT

(76) Inventor: Chin-Fu CHEN, Taichung (TW)

(21) Appl. No.: 12/837,621

(22) Filed: Jul. 16, 2010

(30) Foreign Application Priority Data
May 12, 2010 (TW) 99208828

(51) Int. Cl. E06B 9/386

(52) U.S. Cl. 160/236

(57) ABSTRACT

A Venetian blind slat includes a retaining plate and a core plate attached to the retaining plate in such a way that two opposite sides of the core plate are respectively inserted into notches of the retaining plate. Thus, different core plates with different patterns can be selected to match the interior design for providing high practicability and durability.

### BACKGROUND OF THE INVENTION

1. Field of the Invention

The present invention relates generally to a Venetian blind slat, and more specifically to a Venetian blind slat having high practicability and durability.

2. Description of the Related Art

A conventional Venetian blind slat is a metal or plastic made plate, having patterns on its surface in order to reflect delicacy and aestheticism. However, the conventional Venetian blind slat is difficult to match the interior design because of monotonous and low-selective patterns, and therefore it can be seen that the conventional Venetian blind slat has the disadvantage of low practicability and durability.

### SUMMARY OF THE INVENTION

It is one objective of the present invention to provide a Venetian blind slat, which has high practicability and durability.

To achieve this objective of the present invention, the Venetian blind slat provided by the present invention comprises a retaining plate having a notch at each of two opposite sides thereof, and a core plate attached to a surface of the retaining plate in such a manner that two opposite sides of the core plate are respectively inserted into the notches of the retaining plate.

By means of the aforesaid design, the retaining plate and the core plate are assembled with each other through the inserted connection, increasing the durability of the Venetian blind slat of the present invention. Further, the core plate can be made of different materials and have different patterns on its surface to match the interior design, thereby attaining the purpose of high practicability.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a Venetian blind slat according to a preferred embodiment of the prevent invention;

FIG. 2 is an end view of the Venetian blind slat according to the preferred embodiment of the prevent invention; and

FIGS. 3-5 are top views of the Venetian blind slats according to the preferred embodiment of the prevent invention, in which different core plates are provided.

### DETAILED DESCRIPTION OF THE INVENTION

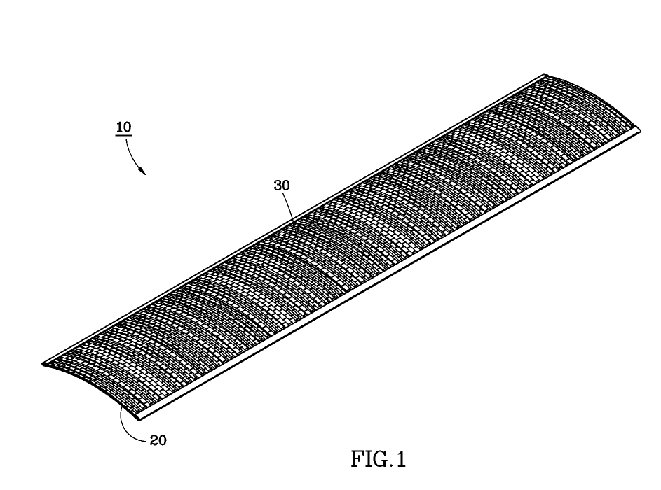

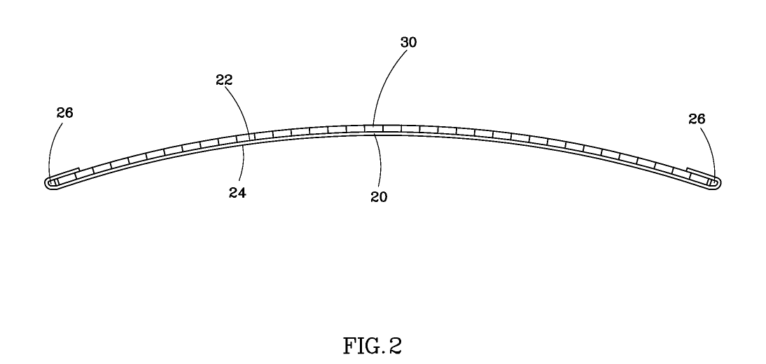

As shown in FIGS. 1 and 2, a Venetian blind slat 10 in accordance with a preferred embodiment of the present invention comprises a retaining plate 20 and a core plate 30.

The retaining plate 20 has a curved crosssection, configuring a convex surface 22 and a concave surface 24 opposite to the convex surface 22. Two opposite sides of the retaining plate 20 are bent toward the convex surface 22 such that a notch 26 is defined between each of the two end edges and the convex surface 22 of the retaining plate 20. Besides, the retaining plate 20 can be made of, but not limited to, metal or plastics, and can be 2 or 3.5 inches in width.

The core plate 30 can be made from one selected from the group consisting of genuine leather, polyvinyl chloride, and artificial leather. The core plate 30 is attached to the convex surface 22 of the retaining plate 20 in such a way that two opposite sides of the core plate 30 are respectively inserted into the notches 26 of the retaining plate 20.

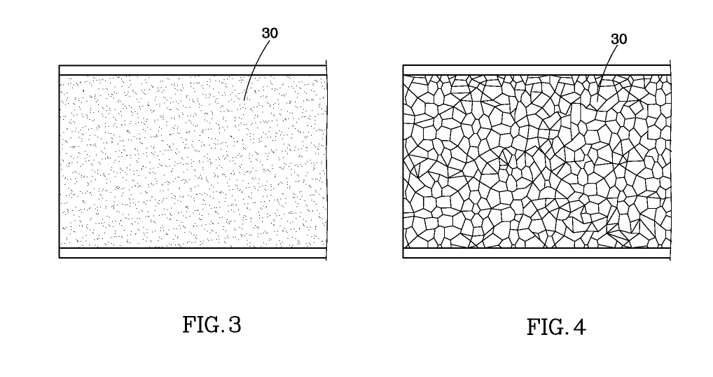

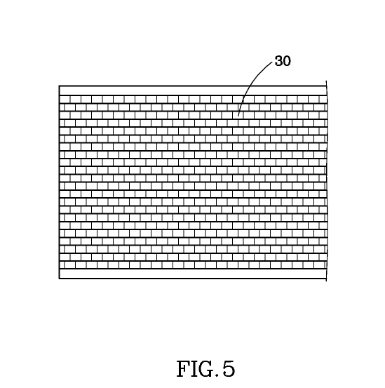

By means of the aforesaid design, since the core plate 30 is retained to the retaining plate 20 by inserted connection such that the core plate 30 can get protection from the retaining plate 30, enhancing the durability of the Venetian blind slat 10 of the present invention. Further, the core plate 30 can be made of different materials in light of the interior design, and different patterns can be provided on the surface of the core plate 30, as shown in FIGS. 3-5, enabling the Venetian blind slat 10 of the present invention to provide high practicability.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Venetian blind slat comprising:
a retaining plate having a notch at each of two opposite sides thereof; and
a core plate attached to a surface of the retaining plate in such a manner that two opposite sides of the core plate are respectively inserted into the notches of the retaining plate.

2. The Venetian blind slat as claimed in claim 1, wherein the retaining plate has a curved crosssection such that the retaining plate has a convex surface, to which the core plate is attached, and a concave surface opposite to the convex surface.

3. The Venetian blind slat as claimed in claim 2, wherein each of the two opposite sides of the retaining plate is bent toward the convex surface of the retaining plate to form one of the notches.

4. The Venetian blind slat as claimed in claim 1, wherein the retaining plate is 2 inches in width.

5. The Venetian blind slat as claimed in claim 1, wherein the retaining plate is 3.5 inches in width.

6. The Venetian blind slat as claimed in claim 1, wherein the core plate is made from one selected from the group consisting of genuine leather, polyvinyl chloride, and artificial leather.

7. The Venetian blind slat as claimed in claim 1, wherein the retaining plate is made of metal or plastics.
